(19) United States
(12) Patent Application Publication
(10) Pub. No.: US 2026/0039984 A1
(43) Pub. Date: Feb. 5, 2026

(54) BROADBAND NETWORK WITH FIBER CABLE AND COAXIAL CABLE

(71) Applicant: TECHNETIX B.V., Veenendaal (NL)

(72) Inventors: Jan ARIESEN, Veenendaal (NL); Paul BROADHURST, Hassocks (GB); Prempton BOGAJ, Veenendaal (NL); Ade BRITTIAN, Veenendaal (NL)

(21) Appl. No.: 19/237,867

(22) Filed: Jun. 13, 2025

(30) Foreign Application Priority Data
Aug. 1, 2024 (GB) 2411326.8
Jan. 27, 2025 (GB) 2501141.2

(51) Int. Cl. H04Q 11/00; H04J 14/02

(52) U.S. Cl. CPC H04Q 11/0071; H04J 14/0242; H04Q 2011/009

(57) ABSTRACT

There is provided a broadband network (2) comprising fiber cable and unreplaceable sections of coaxial cable (22) associated with buildings used by end users of the network, wherein a wireless signal transmitter/receiver (24, 26) is connected at each end of each unreplaceable section of the coaxial cable (22) to convert Ethernet signals to electrical signals to pass along the unreplaceable section of the coaxial cable (22). Electrical power for wireless signal transmitters/receivers (24, 26) is provided from a power source (40) associated with a user building, electrical power routed along the unreplaceable section of coaxial cable to reach at least one wireless signal transmitter/receiver (24). A method of conveying signals within a broadband network comprising fiber cable and unreplaceable sections of coaxial cable is also provided.

This application claims priority to United Kingdom Patent Application Nos. GB 2411326.8, filed on Aug. 1, 2024, and GB 2501141.2, filed on Jan. 27, 2025, both which are incorporated by reference for all purposes as if fully set forth herein.

### FIELD OF THE INVENTION

The present invention relates to a broadband network comprising fiber cable and unreplaceable sections of coaxial cable associated with buildings used by end users of the network.

### BACKGROUND TO THE INVENTION

As the requirement for faster broadband network speeds continues to increase, existing coaxial cable or copper pair networks need to be updated from coaxial to Fiber to the Home (FTTH) or Fiber to the Premises (FTTP). Coaxial cable needs to be replaced by a fiber cable and existing coaxial modem equipment in the home replaced by an optical transmitter/receiver called an ONT (Optical Network Termination) or an ONU (Optical Network Unit) that delivers data to the building via an Ethernet connector to a wired or wireless data distribution router networking system within the building.

Placement of coaxial cable tends to differ depending on country. Some countries have an outside network (feeding from telegraph or utility poles) where replacing coaxial or copper cable pair with new fiber cable is a relatively simple change. Some networks have the existing coaxial cable or copper pair in tubes called ducts where the replacement is also quite straightforward involving pulling out the existing cable and blowing a new fiber cable into the duct. In other countries the coaxial cable is directly buried (rather than in ducts) in the ground under streets or pavements under a road surface such as asphalt, concrete or paving stones and this is more challenging. The only way the update to fiber can be done for a direct buried network is by digging a new trench under the road surface to run the new fiber. Reinstating the road surface after placement of the fiber can be very costly and time consuming.

There are often circumstances where it is impossible, or prohibitively expensive to install new fiber cables to premises. These circumstances apply in both Single Dwelling Units (SDUs) and Multiple Dwelling Units (MDUs) and may be caused by different factors and reasons. For example over a period of time, existing coaxial and copper “Drop” cables may have become inaccessible; installed behind walls, within ceilings, directly buried underground and/or within conduits which have become concealed, crushed or blocked. It is therefore impossible to replace cabling or install new conduits without causing significant disruption and/or permanently affecting the aesthetics of the property.

Landlords, tenants and home owners can be reluctant to permit disruptive works; negotiations become even more complicated and protracted where a property has shared ownership, or is the responsibility of a managing agent, residents committee etc. as is often in the case of MDUs and shared driveways.

Lastly, the coaxial cable within a customer's garden may need to be replaced. Often customers don't want the disturbance and disruption of digging in their garden and therefore they decide not to be connected to the fiber to the home network. This is a big problem because the network provider then either loses a customer or needs to maintain two networks of coaxial cable and fiber.

### SUMMARY OF THE INVENTION

In accordance with one aspect of the invention, there is provided a broadband network comprising fiber cable and unreplaceable sections of coaxial cable, i.e. required to remain in situ, associated with buildings used by end users of the network, wherein a wireless signal transmitter/receiver is connected at each end of each unreplaceable section of the coaxial cable to convert Ethernet signals to electrical signals to pass along the unreplaceable section of the coaxial cable. By converting the Ethernet signals into electrical signals for transmission along the unreplaceable section of the coaxial cable, faster data speeds are possible along the unreplaceable section of coaxial cable.

The electrical signals typically include a wireless protocol, known to the person skilled in the art.

Preferably electrical power for the wireless signal transmitters/receivers is provided from a power source associated with a user building, electrical power routed along the unreplaceable section of coaxial cable to reach at least one wireless signal transmitter/receiver.

The electrical power is preferably routed along the unreplaceable section of coaxial cable to power an optical transmitter/receiver located between the fiber cable and the section of unreplaceable coaxial cable.

The unreplaceable sections of coaxial cable may have a length between 0.5 to 50 m.

The wireless signal transmitters/receivers may be Wi-Fi transmitters/receivers.

Alternatively the wireless signal transmitters/receivers may be configured for wireless protocols other than Wi-Fi, such as LTE.

The optical transmitter/receiver and the wireless signal transmitter/receiver proximal to the optical transmitter/receiver may be combined as a PON ONT unit so as to allow a customer to receive Full-Fiber broadband services such as XGS PON and GPON.

In accordance with another aspect of the invention, there is also provided a method of conveying signals within a broadband network comprising fiber cable and unreplaceable sections of coaxial cable associated with buildings used by end users of the network, the method comprising connecting a wireless signal transmitter/receiver at each end of each unreplaceable section of coaxial cable, converting Ethernet signals using the electrical signal transmitter/receivers into wireless signals and transmitting the electrical signals along the unreplaceable sections of coaxial cable.

The method may further comprise providing electrical power for the wireless signal transmitters/receivers from a power source associated with an end user building, electrical power routed along each unreplaceable section of coaxial cable to reach the wi-fi transmitter/receivers.

Preferably the method comprises routing electrical power along the unreplaceable section of coaxial cable to power an optical transmitter/receiver located between the fiber cable and the coaxial cable.

The invention will now be described, by way of example, with reference to the accompanying drawings in which:

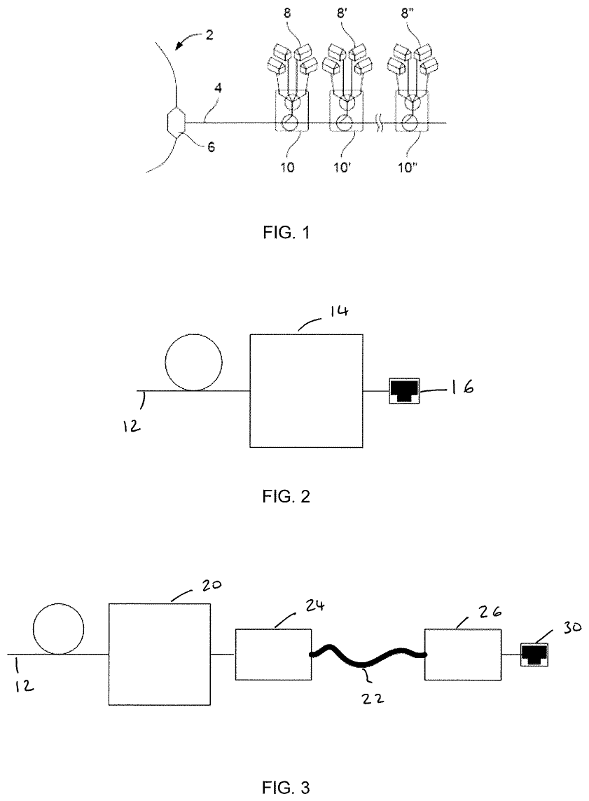

FIG. 1 is a schematic representation of a broadband cable TV network;

FIG. 2 is a schematic representation of part of the network with fiber cable;

FIG. 3 is a schematic representation of part of the network retaining a section of coaxial cable;

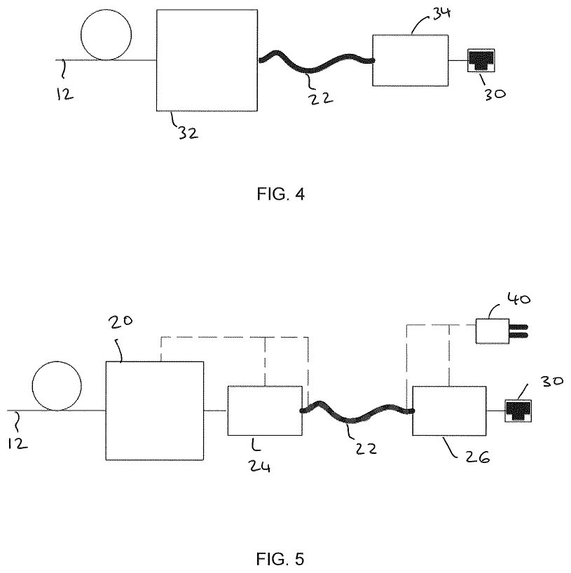

FIG. 4 is a schematic representation of part of the network retaining a section of coaxial cable and configured for full-fiber broadband services; and

FIG. 5 is a schematic representation to illustrate powering of elements shown in FIG. 3.

### DESCRIPTION

FIG. 1 is a schematic representation of part of a typical broadband cable TV network. The network (indicated generally by reference numeral 2) comprises a coaxial cable 4 which carries the broadband signal from a local distribution node 6, to a plurality of network users or subscribers 8-8″” via one or more of the intervening signal distribution (4-way) tap components 10-10″″.

When upgrading the network to replace coaxial cable with optical fiber cable so as to increase the speed of data transmission, coaxial cable 4 needs to be replaced by fiber cable 12, as shown in FIG. 2, and existing coaxial modem equipment in a building replaced by an optical transmitter/receiver 14 called an ONT (Optical Network Termination) unit or an ONU (Optical Network Unit) that delivers data to the building via an Ethernet connector 16 to a wired or wireless data distribution router networking system within the building.

Generally the coaxial cable can be readily replaced with fiber cable for the upgrade. However the last section of coaxial cable closest to the end user's building often cannot be replaced, for example where end users of the network refuse to have their gardens dug up. This means the network provider then either loses a customer or needs to maintain two networks of coaxial cable and fiber. Copper drop cables are a specific type of coaxial cable also used in such networks.

Full-Fiber broadband services such as XGS PON and GPON require an individual Optical Network Terminal (ONT) unit per subscriber, which provides a means of terminating the fiber and converting the Passive Optical Network (PON) signals into usable electronic and wireless data signals. Consumers typically access these data services in the home on devices such as Laptops, Phones and Tablets which require Ethernet and/or Wi-Fi connections via a router.

Currently, unless an Internet Service Provider (ISP) installs a new fiber cable and ONT unit at each subscriber premises, the customer cannot be connected to the ISP's FTTP/FTTH network and therefore cannot benefit from Full-Fiber broadband services such as XGS PON and GPON.

Where the coaxial cable, or copper drop cable, near an end user's building is required to remain in situ and is unreplaceable, in accordance with the invention and as shown in FIG. 3, an optical transmitter/receiver 20 is positioned at the end of fiber cable 12, typically on the side of the road or pavement or the entrance of a garden, and connected to an unreplaceable section of coaxial cable 22 using a first wireless signal transmitter/receiver 24 with a second wireless signal transmitter/receiver 26 connected at the end of cable 22 proximal the user building within which Ethernet connector 30 is located. Optical transmitter/receiver 20 generates an Ethernet signal which is converted into an electrical signal using first wireless signal transmitter/receiver 24 for transmission over the coaxial cable 22. Second wireless signal transmitter/receiver 26 connected at the end of cable 22 proximal the user building receives the wireless signal and generates an Ethernet signal which is transmitted through the user building using Ethernet connector 30.

By converting the signals from optical transmitter/receiver 20 into electrical signals, faster data speeds are possible along the unreplaceable section of coaxial cable 22 than would be possible for coaxial cable within an entirely coaxial network with no fiber cable. Further, there is then no need to maintain a separate fiber network and a separate coaxial network where there are unreplaceable sections of coaxial cable. Thus the “old” coaxial cable 22 is used to deliver the faster data associated with fiber cable to the home.

The functionality of optical transmitter/receiver 20 and wireless transmitter/receiver 24 can be combined into a PON ONT unit 32, as shown in FIG. 4, connected directly to an Internet Service Provider (ISP) optical full-fiber network. This unit is installed remotely, away from the customer premises, and thus connectable to the end of the unreplaceable section of coaxial cable furthest from the customer premises. This remote PON ONT Unit provides an integrated data transceiver which allows the conversion of full-fiber services such as XGS PON and GPON into data signals suitable for transmission over existing coaxial and/or copper drop cables.

Where a remote PON ONT unit 32 is used, wireless transmitter/receiver 26 is configured as an adapter 34 bridging the connection to the remote PON ONT unit. This adapter includes an integrated transceiver to be able to transmit and receive electrical signals, and a multi-gigabit data port, enabling the full-fiber data services to be sent/received at the premises through Ethernet/Wi-Fi router 30.

A standard protocol such as Wi-Fi is typically used to generate the electrical signal, for example Wi-Fi 7 in accordance with IEEE standard 802.11be, and as such wireless signal transmitter/receivers 24, 26 are Wi-Fi transmitter/receivers. Alternative wireless protocols such as LTE can be used to convert the Ethernet signal into an electrical signal for transmission over the unreplaceable section of coaxial cable 22, with then electrical signal transmitter/receivers 24, 26 being configured for these protocols.

Any data over coax/copper protocol along with bonding any combination of advanced, alternative data transmission protocols can be used, for example: MoCA2.5 (Multi-Media over Coax Alliance version 2.5) for >2 Gbps symmetrical data rates over existing drop cables.

MoCA3 (Multi-Media over Coax Alliance version 3) for 10 Gbps symmetrical data rates over existing drop cables.

10G BASE T1 (Automotive Ethernet) for 10 Gbps symmetrical data rates 802.11.x (All current/future generations of WIFI) Current and future Mobile Transmission variants, as ratified 3 GGP standards (e.g 4G, 5G New Radio, 6G).

The remote PON ONT unit 32 ensures adaptability for all of the above data transmission protocols and future variants. Where combinations of transmission variants and/or protocols are enabled, the remote PON ONT unit provides link aggregation functionality to effectively bond the combined RF spectrum capacity and bandwidth, maximising the data transmission throughput.

Conventional ONTs are usually installed inside customer premises which are environmentally stable and where this is a low risk of exposure to water and/or dust ingress. The remote PON ONT unit 32 is designed to be safely, remotely installed in harsh environments, such as in underground chambers, manholes, Toby boxes (hand-holes), on Telegraph poles, external building facades and on/inside street furniture. The remote PON ONT unit 32 can also survive being submerged underwater for significant periods of time without impacting service, such as when chambers become flooded.

As optical transmitter/receiver 20 (ONU or ONT), remote PON ONT unit 32, adapter 34, and wireless signal transmitter/receivers 24, 26 require electrical power, this can be supplied from the building along the unreplaceable section of coaxial cable 22 as shown by the dashed lines in FIG. 5. Thus electrical power source 40 within the user building supplies electrical power to wireless signal transmitter/receiver 26 and to coaxial cable 22, with electrical power routed along coaxial cable 22 to provide a power source to optical transmitter/receiver 20 and wireless signal transmitter/receiver 24. In a similar way, all remote PON ONT units are powered remotely via the coaxial or copper drop cable using a power supply and integrated power injector in adapter 34 at the customer premises.

With above implementation, fast data can be conveyed over fiber cable to reach an unreplaceable section of coaxial cable in a garden, and then the fast data transported over coaxial cable 22 as electrical signals for the last few meters. Typically the unreplaceable section of coaxial cable has a length of between 0.5 m to 50 m depending on the size of garden although more usually the length will be between 0.5 m to 5 m. Optical transmitter/receiver 20, wireless transmitter/receivers 24, 26, remote PON ONT unit 32 and adapter 34 can be powered from the building of the end user.

For security and to prevent accidental/unauthorized access, encrypted pairing protocols are adopted between the remote PON ONT unit 32 and accompanying adapter 34 which can only be enabled/disabled by the ISP. These effectively pair a specific A-end (remote) device to a specific B-end (in-home) adapter, preventing access to any other device which may be connected to the coax/copper drop cable.

1. A broadband network comprising fiber cable and unreplaceable sections of coaxial cable associated with buildings used by end users of the network, wherein a wireless signal transmitter/receiver is connected at each end of each unreplaceable section of the coaxial cable to convert Ethernet signals to wireless electrical signals to pass along the unreplaceable section of the coaxial cable.

2. A broadband network according to claim 1, wherein electrical power for the wireless signal transmitters/receivers is provided from a power source associated with a user building, electrical power routed along the unreplaceable section of coaxial cable to reach at least one wireless signal transmitter/receiver.

3. A broadband network according to claim 1, wherein electrical power is routed along the unreplaceable section of coaxial cable to power an optical transmitter/receiver located between the fiber cable and the section of unreplaceable coaxial cable.

4. A broadband network according to claim 1, wherein the unreplaceable sections of coaxial cable have a length between 0.5 to 50 m.

5. A broadband network according to claim 1, wherein the wireless signal transmitters/receivers are Wi-Fi transmitters/receivers.

6. A broadband network according to claim 1, wherein the optical transmitter/receiver and the wireless signal transmitter/receiver proximal to the optical transmitter/receiver are combined as a PON ONT unit.

7. A broadband network according to claim 1, wherein the wireless signal transmitters/receivers are configured for LTE.

8. A method of conveying signals within a broadband network comprising fiber cable and unreplaceable sections of coaxial cable associated with buildings used by end users of the network, the method comprising connecting a wireless signal transmitter/receiver at each end of each unreplaceable section of coaxial cable, converting Ethernet signals using the wireless signal transmitter/receivers into wireless electrical signals and transmitting the wireless electrical signals along the unreplaceable sections of coaxial cable.

9. A method in accordance with claim 8, further comprising providing electrical power for the wireless signal transmitters/receivers from a power source associated with an end user building, electrical power routed along each unreplaceable section of coaxial cable to reach the wi-fi transmitter/receivers.

10. A method in accordance with claim 8, further comprising routing electrical power along the unreplaceable section of coaxial cable to power an optical transmitter/receiver located between the fiber cable and the coaxial cable.

11. A method in accordance with claim 8 wherein the unreplaceable sections of coaxial cable have a length between 0.5 to 50 m.

12. A method in accordance with claim 8, wherein the wireless signal transmitters/receivers are Wi-Fi transmitters/receivers.

13. A method in accordance with claim 8, wherein the optical transmitter/receiver and the wireless signal transmitter/receiver proximal to the optical transmitter/receiver are combined as a PON ONT unit.

14. A method in accordance with claim 8, wherein the wireless signal transmitters/receivers are configured for LTE.

15. A broadband network according to claim 1, wherein the electrical signals comprise a wireless protocol.
